(19) United States
(12) Patent Application Publication
(10) Pub. No.: US 2008/0062075 A1
(43) Pub. Date: Mar. 13, 2008

(54) GAS DISCHARGE DISPLAY DEVICE

(76) Inventors: Yoshiho Seo, Akashi-shi (JP); Kazushige Takagi, Akashi-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/740,952

(22) Filed: Apr. 27, 2007

(30) Foreign Application Priority Data
Sep. 12, 2006 (JP) 2006-247333

(51) Int. Cl. G09G 3/28

(52) U.S. Cl. 345/60

(57) ABSTRACT

A gas discharge display device is provided which includes a screen for color display in which pixels are arranged in a matrix, each of the pixels being made up of three cells having different light emission colors, and a driving circuit that is configured for replacing each multi-gradation frame with a plurality of two-gradation subframes and for performing write addressing operation on each of the subframes, so that the subframes are displayed in order. For display of the leading subframe in display of each of the frames, the driving circuit causes, among the cells making up the screen, a non-minimum brightness cell to be lit and causes at least one cell adjacent to the non-minimum brightness cell to be forcibly lit, the non-minimum brightness cell being a cell whose corresponding multi-gradation data has a value that is not a value indicating minimum brightness.

### BACKGROUND OF THE INVENTION

1. Field of the Invention

The present invention relates to a gas discharge display device including a device, such as a plasma display panel or a plasma address liquid crystal, which emits light due to gas discharges.

2. Description of the Related Art

AC plasma display panels are used for color image display. For display using a plasma display panel of this type, line-sequential scanning addressing operation is performed, and after that, lighting sustain operation (sustain operation) is performed in which display discharges are generated plural times depending on a gradation value of display data. The addressing operation is setting operation of lit/non-lit in which, among cells that are light emission elements making up a screen, more wall charges are caused to be charged in cells to be lit than in other cells. With write addressing operation, address discharges are generated only in cells to be lit. With erase addressing operation, address discharges are generated only in cells not to be lit.

In order to generate address discharges certainly, it is required to apply, to cells, voltage pulses having a pulse width longer than discharge delay time. However, attempting to increase the definition and the resolution of a screen with this requirement satisfied is difficult. The increase in the definition of a screen involves reducing a cell size. The reduction in cell size hinders discharges from occurring. Stated differently, the discharge delay time becomes longer. The improvement in the resolution causes the increase in the resolution in the horizontal direction, which shortens scan time per display line. Consequently, the pulse width needs shortening.

As for the shortening of the discharge delay time, Japanese unexamined patent publication No. 2002-297091 proposes that an auxiliary electrode pair is disposed near a scan electrode to generate priming discharges. Further, as one of the improvements, Japanese unexamined patent publication No. 2005-216593 proposes that priming discharges are generated in auxiliary cells that are defined by a partition in order to prevent crosstalk from occurring. The crosstalk occurs as the result of excess supply of space charges due to priming discharges.

The change in panel structure such as the addition of electrode pairs or auxiliary cells for priming discharges reduces an opening ratio that is a ratio of an effective light emission area of each cell and lowers display brightness. Besides, the change complicates a manufacture process of display devices and reduces the proper product ratio.

### SUMMARY

The present disclosure is directed to solve the problems pointed out above, and therefore, an object of an embodiment of the present invention is to improve the reliability of addressing operation without disposing an element specialized in priming discharges on a screen.

According to an embodiment of the present invention, a gas discharge display device includes a screen for color display in which pixels are arranged in a matrix, each of the pixels being made up of three cells having different light emission colors, and a driving circuit that is configured for replacing each multi-gradation frame with a plurality of two-gradation subframes and for performing write addressing operation on each of the subframes, so that the subframes are displayed in order. For display of the leading subframe in display of each of the frames, the driving circuit causes, among the cells making up the screen, a non-minimum brightness cell to be lit and causes at least one cell adjacent to the non-minimum brightness cell to be forcibly lit. The non-minimum brightness cell is a cell whose corresponding multi-gradation data has a value that is not a value indicating minimum brightness.

The phrase “forcibly lit” herein means that a target cell is caused to be lit irrespective of a multi-gradation data value corresponding to the target cell. Since the addressing operation is write addressing operation, address discharges are generated in cells to be lit in the addressing operation.

A non-minimum brightness cell is a cell to be lit in at least one of a plurality of subframes. The non-minimum brightness cell is forcibly lit in the leading subframe. Thereby, priming effects due to space charges caused by display discharges in the leading subframe and the activation of a dielectric surface including a protection film due to the display discharges cause address discharges to occur easily in the second or later subframes, leading to the prevention of occurrence of address discharge errors.

Besides, at the time of the lighting in the leading subframe, cells adjacent to the non-minimum brightness cell are forcibly lit in addition to the non-minimum brightness cell. In other words, “isolated lighting” is prevented in which the non-minimum brightness cell is enclosed by cells that are not lit, i.e., minimum brightness cells. Thereby, address discharges occur easily for the reasons described below.

Since address discharges are generated in a plurality of cells adjacent to one another, a leakage electric field from the adjacent cells is added and an electric field is increased when address voltage is applied to cells for generating address discharges. In addition, priming particles due to address discharges that are generated first in cells where discharges occur relatively easily among a plurality of cells pass through a microgap between partition top surfaces and a surface opposite thereto and flow out to the adjacent cells, which produces a priming effect in the adjacent cells.

In the case where a non-minimum brightness cell should not be lit originally in the leading subframe, i.e., in the case where a multi-gradation data value is a value indicating that only single or plural subframes that are provided as the second or later subframes should be lit, the non-minimum brightness cell is forcibly lit in the leading subframe, which influences the display quality. As countermeasures against this, the brightness weight of the leading subframe is reduced, and thereby the influence can be reduced. In practice, the influence that an address discharge error occurs in a subframe having large brightness weight is more serious than the influence that a subframe having small brightness weight is lit. However, when the present invention is embodied, it is not necessarily required to set the brightness weight value of the leading subframe to the minimum value. The number of times of display discharges in a subframe increases and the activation of a dielectric surface including a protection film increases with increasing the brightness weight. This greatly contributes to the reduction in address discharge errors in the subsequent subframes. In light of this, it is desirable that the brightness weight of the leading subframe is properly selected depending on address discharge characteristics of the screen.

The structure discussed above enables the improvement of reliability of addressing operation without disposing an element specialized in priming discharges on a screen aside from an element for address discharges.

These and other characteristics and objects of the present invention will become more apparent by the following descriptions of preferred embodiments with reference to drawings.

### BRIEF DESCRIPTION OF THE DRAWINGS

FIG. 1 is a diagram showing a structure of a gas discharge display device according to an embodiment of the present invention.

FIG. 2 is a diagram showing a color array in a screen.

FIG. 3 is an exploded perspective view showing an example of a cell structure in a screen.

FIG. 4 shows an example of a conversion table relating to frame division.

FIG. 5 is a diagram showing a first example of a lighting pattern modification.

FIG. 6 is a diagram showing an example of a circuit that achieves the first example of the lighting pattern modification.

FIG. 7 is a diagram showing a second example of a lighting pattern modification.

FIG. 8 is an explanatory diagram of a process to which a plurality of pixels is related.

FIG. 9 is a diagram showing an example of a circuit that achieves the second example of the lighting pattern modification.

FIG. 10 is a diagram showing a third example of a lighting pattern modification.

FIG. 11 is a diagram showing an example of a circuit that achieves the third example of the lighting pattern modification.

FIG. 12 is a diagram showing a color array in a screen according to a fourth example.

FIG. 13 is a diagram showing a fourth example of a lighting pattern modification.

FIG. 14 is a diagram showing an example of a circuit that achieves the fourth example of the lighting pattern modification.

### DESCRIPTION OF THE PREFERRED EMBODIMENTS

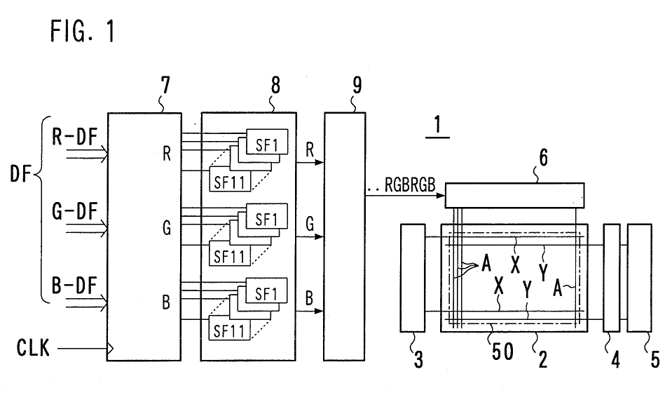

FIG. 1 is a diagram showing a structure of a gas discharge display device according to an embodiment of the present invention. The illustrated gas discharge display device 1 includes a plasma display panel 2 having a screen 50 for color display, and a plurality of circuits for driving the plasma display panel 2.

On the screen 50 are disposed first display electrodes X, second display electrodes Y and address electrodes A. The display electrodes Y are used as scan electrodes in addressing operation. The display electrodes Y and the address electrodes A form an electrode matrix for the addressing operation. A sustain driver 3 is connected to the display electrodes X while a scan driver 4 and a sustain driver 5 are connected to the display electrodes Y. Then, an address driver 6 is connected to the address electrodes A.

An image output device (not shown) such as a TV tuner or a computer outputs to the gas discharge display device 1 data R-DF, G-DF and B-DF together with a clock CLK for transferring pixels. The data R-DF, G-DF, and B-DF indicate gradation values (brightness) of three colors of R, G and B, respectively. Frame data DF is made up of the data R-DF, G-DF and B-DF.

Since the plasma display panel 2 is a binary light emission device, the gas discharge display device 1 displays a multi-gradation frame in the form of a plurality of two-gradation subframes. To that end, the gas discharge display device 1 includes a frame division circuit 7 for converting frame data DF into subframe data, a memory 8 for storing the subframe data temporarily and a data transfer circuit 9 for reading out predetermined subframe data from the memory 8 to send the same to the address driver 6.

The frame division circuit 7 converts the data R-DF, G-DF and B-DF into subframe data, respectively. The subframe data is a set of data in which one bit corresponds to one cell. A value of each bit indicates whether a cell is to be lit or not in the corresponding subframe, more specifically whether address discharges are necessary or not. In the illustrated example, the number of subframes is eleven. In the following description, the subframes from the leading subframe through the last subframe in display order are referred to as SF1, SF2, . . . SF10 and SF11 in order. The drawings conform to this.

In addressing operation performed on the respective subframes SF1-SF11, the data transfer circuit 9 reads out subframe data of three colors in the order corresponding to the color array in the screen 50 and serially outputs the subframe data thus read out to the address driver 6 in synchronism with scan of display lines.

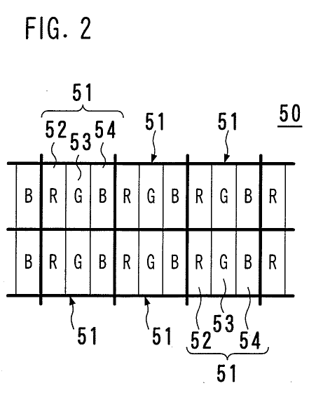

Referring to FIG. 2, the color array in the screen 50 is an array in which three colors of R, G and B are provided repeatedly in this order in the horizontal direction and cells having the same color are placed in the vertical direction. In the screen 51, a set of cells corresponding to one pixel of an image is made up of three cells, that is, a G (green) cell 53, an R (red) cell and a B (blue) cell that are adjacent to the G cell 53. Herein, the set of cells corresponding to one pixel of an image is referred to as a pixel for convenience.

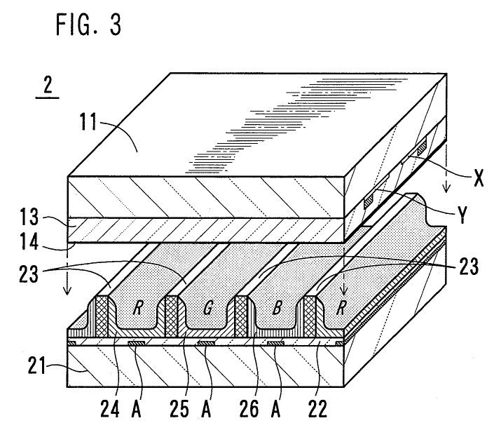

FIG. 3 shows a typical example of a cell structure. The display electrodes X and the display electrodes Y are disposed on a front glass substrate 11 and are covered with a dielectric layer 13 and a protection film 14. The address electrodes A are disposed on a rear glass substrate 21 and are covered with a dielectric layer 22. Partitions 23 for dividing a gas-sealed space are disposed on the dielectric layer 22 at regular intervals. An R fluorescent material 24, a G fluorescent material 25 and a B fluorescent material 26 that determine a cell color are disposed in respective gaps between the partitions. In practice, the top faces of the partitions 23 abut on the protection film 14 while they are away from each other in the drawing.

The addressing operation is write addressing operation in which address discharges are generated in cells to be lit for display of the corresponding subframe. Voltage for generating address discharges between the display electrode Y and the address electrode A is applied to cells to be lit. The address discharges form an appropriate amount of wall charge.

In the sustaining operation following the addressing operation, alternating voltage is applied at an electrode pair of the display electrode X and the display electrode Y. Display discharges are generated only in cells to be lit and an ultra violet ray emitted by a discharge gas excites the fluorescent materials 24, 25 and 26. Thereby, the fluorescent materials 24, 25 and 26 emit light. The light emission due to the display discharges is lighting.

For display of the leading subframe SF1 in display of each of frames, the gas discharge display device 1 having the structure described above causes a non-minimum brightness cell to be lit and causes at least one cell adjacent to the non-minimum brightness cell to be forcibly lit. Herein, the non-minimum brightness cell is, among the cells 51 making up the screen 50, a cell whose corresponding frame data DF has a value that is not a value indicating the minimum value (zero in general cases). In this embodiment, such characteristic operation is achieved by the frame division circuit 7. More specifically, the frame division circuit 7 generates subframe data indicating that a non-minimum brightness cell and cells adjacent thereto are caused to be lit in the subframe SF1.

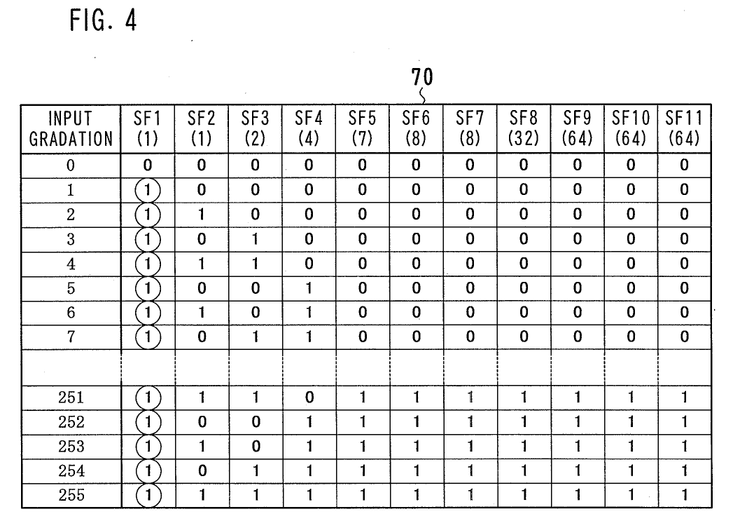

The frame division circuit 7 includes a portion for converting frames into subframes, e.g., a conversion table 70 as shown in FIG. 4, and a portion for modifying a conversion result for the subframe SF1 as specified in first through fourth examples described below.

In the conversion table 70, a combination of lit/non-lit (a lighting pattern) of eleven subframes SF1-SF11 is associated with, for example, each of gradation values (0-255) of frame data DF having 256 gradations. In FIG. 4, numerals in parentheses denote respective brightness weight. The lit state is denoted by “1” while the non-lit state is denoted by “0”.

As is highlighted by circles in FIG. 4, an important feature of the conversion table 70 is that the subframe SF1 is set to be lit with respect to all the gradation values “1” to “255” except for the gradation value “zero” that indicates the minimum brightness. For example, as a lighting pattern for displaying the gradation value “7”, there are a pattern in which the subframes SF2-SF4 are set to be lit and a pattern in which only the subframe SF5 is set to be lit. However, in the conversion table 70, the gradation value “7” corresponds to a pattern in which the subframes SF1, SF3 and SF4 are set to be lit. In this way, in the conversion table 70, with respect to gradation values for each of which a plurality of expressible lighting patterns is provided, a pattern in which the subframe SF1 is set to be non-lit is not used, and instead, a pattern in which the subframe SF1 is set to be lit is used.

According to the conversion based on the conversion table 70, in the case of display of the leading subframe SF1, non-minimum brightness cells corresponding to the gradation values “1”-“255” are caused to be lit. The lighting in the subframe SF1 prevents address discharge errors from occurring in the subframe SF2 and the subsequent subframes SF3-SF11 in non-minimum brightness cells corresponding to the gradation values “2”-“255”.

With the conversion table 70, the lighting of the non-minimum brightness cells in the subframe SF1 is not additional lighting for priming but genuine lighting in which gradation values of frame data DF are expressed. Thus, the display quality is not deteriorated at all.

Note that the number of subframes corresponding to one frame, brightness weight of each subframe, and weight array (the display order of subframes) are not limited to the exemplification. In particular, it is desirable that the weight array is an array effective in reducing pseudo contours and is not limited to the order of the weight.

### FIRST EXAMPLE

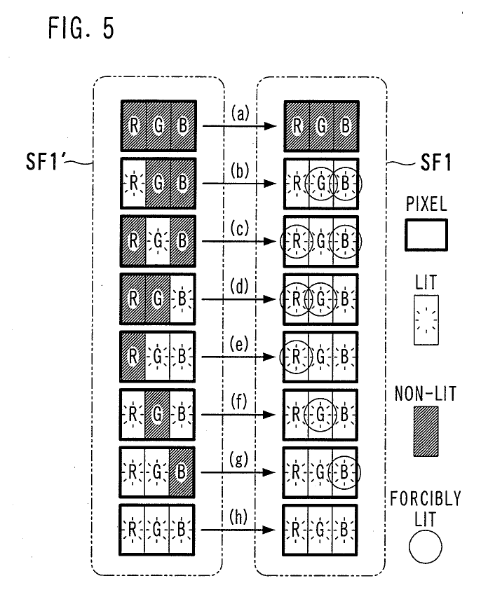

FIG. 5 is a diagram showing a first example of a lighting pattern modification. In this example, a display color of the subframe SF1 is modified to an achromatic color (monochrome). In a subframe (hereinafter referred to as a subframe SF1′) before the modification in accordance with the conversion table 70 shown in FIG. 4, a non-minimum brightness cell is lit in the subframe SF1. However, if cells around the non-minimum brightness cell are minimum brightness cells, lighting in the non-minimum brightness cell is isolated lighting. According to the first example, for the purpose of eliminating the isolated lighting, all three cells that belong to a pixel including a non-minimum brightness cell are caused to be lit as shown in (b)-(h) of FIG. 5. Since cells of three colors emit light, an emission color of the pixel including the non-minimum brightness cell is white. In the case of a pixel in which all three cells are minimum brightness cells, the state remains unchanged regardless of the modification as shown in (a) of FIG. 5. In short, the three cells are non-lit in the subframe SF1.

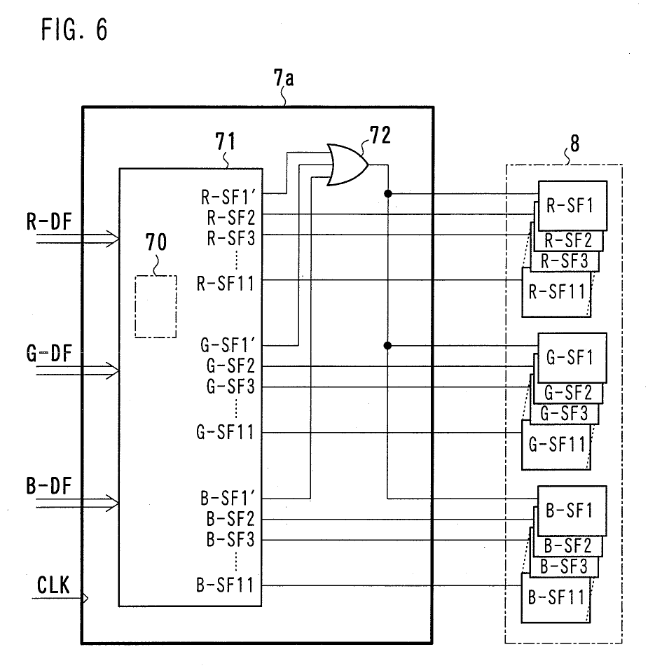

The first example of such a lighting pattern modification can be achieved by a frame division circuit 7a having a structure shown in FIG. 6.

The frame division circuit 7a includes a block 71 that converts frame data R-DF, G-DF and B-DF of three colors into subframe data R-SF1′, R-SF2 to R-SF11, G-SF′1, G-SF2 to G-SF11, B-SF1′, B-SF2 to B-SF11 in accordance with the conversion table 70, and a logic circuit 72 that performs a logical OR operation of the subframe data R-SF1′, G-SF1′ and B-SF1′ outputted by the block 71.

The subframe data of the subframes SF2 to SF11 outputted by the block 71 are written onto the memory 8 without any modifications. As for the leading subframe SF1, the output by the logic circuit 72 is written onto the memory 8 for three colors in common.

Note that the function of the block 71 may be achieved by a look-up table (LUP) or a logical operation circuit.

### SECOND EXAMPLE

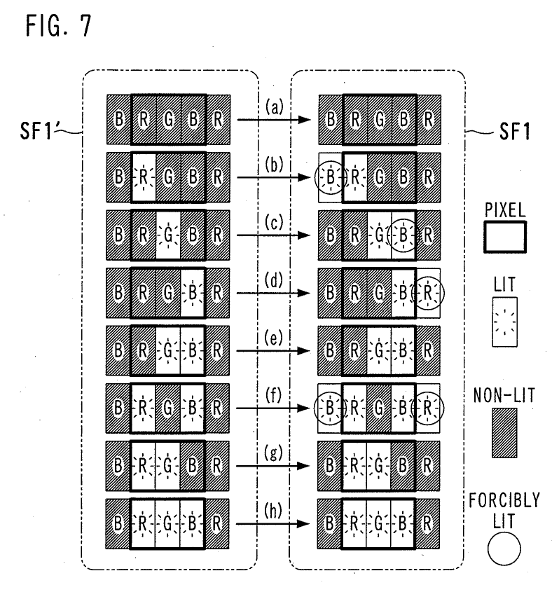

FIG. 7 is a diagram showing a second example of a lighting pattern modification. According to the second example, B (blue) cells or R (red) cells that have generally low visibility out of three colors are forcibly lit. Thereby, isolated lighting of a non-minimum brightness cell is eliminated. In general, the relative ratio of visibility of R, G and B is 3:6:1 or a value close thereto. Accordingly, display quality is less affected by the forcible lighting of B or R cells, compared to the forcible lighting of G (green) cells.

In a color array in which R, G and B are provided in this order from the left, in the case where an R cell in a target pixel is lit in isolation, a B cell in the left pixel is caused to be lit as shown in (b) of FIG. 7. In the case where a G cell in a target pixel is lit in isolation, a B cell in the target pixel is caused to be lit as shown in (c). In the case where a B cell in a target pixel is lit in isolation, an R cell in the right pixel is caused to be lit as shown in (d). When G and B cells in a target pixel are lit or when R and G cells in a target pixel are lit, the lighting pattern is not modified as shown in (e) or (g) because such each lighting is not isolated lighting. When R and B cells in a target pixel are lit, a B cell in the left pixel and an R cell in the right pixel are caused to be lit as shown in (f). These lighting pattern modifications are organized focusing on each color cell, and thereby the following logic is derived.

An R cell in a target pixel is lit in the subframe SF1 in the case where the R cell is a non-minimum brightness cell or in the case where a G cell in the target pixel is not lit and a B cell in the left pixel is lit. A G cell in a target pixel is lit in the subframe SF1 only in the case where the G cell is a non-minimum brightness cell. A B cell in a target pixel is lit in the subframe SF1 in the case where the B cell is a non-minimum brightness cell, in the case where a G cell in the target pixel is lit, or in the case where an R cell in the right pixel is lit and a G cell in the target pixel is not lit.

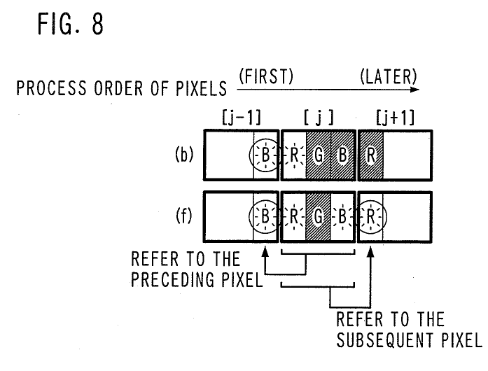

In the second example, when subframe data of the subframe SF1 for B and R cells are determined, a case arises in which attention should be paid to lighting patterns of a plurality of pixels. Specifically, the cases of (b), (d) and (f) of FIG. 7 correspond to that case. In these cases, it is necessary to refer to adjacent pixels as shown in FIG. 8.

As shown in FIG. 8, frame data is processed in the order of the pixel array. In the illustrated example, the frame data is processed from the left to the right in each row of pixels. Accordingly, in the case of (b), for example, at the stage where the j−1 th pixel is processed, the subsequent j-th pixel is referred to. In addition, in the case of (f), at the stage where the j+1 th pixel is processed, the preceding j-th pixel is referred to.

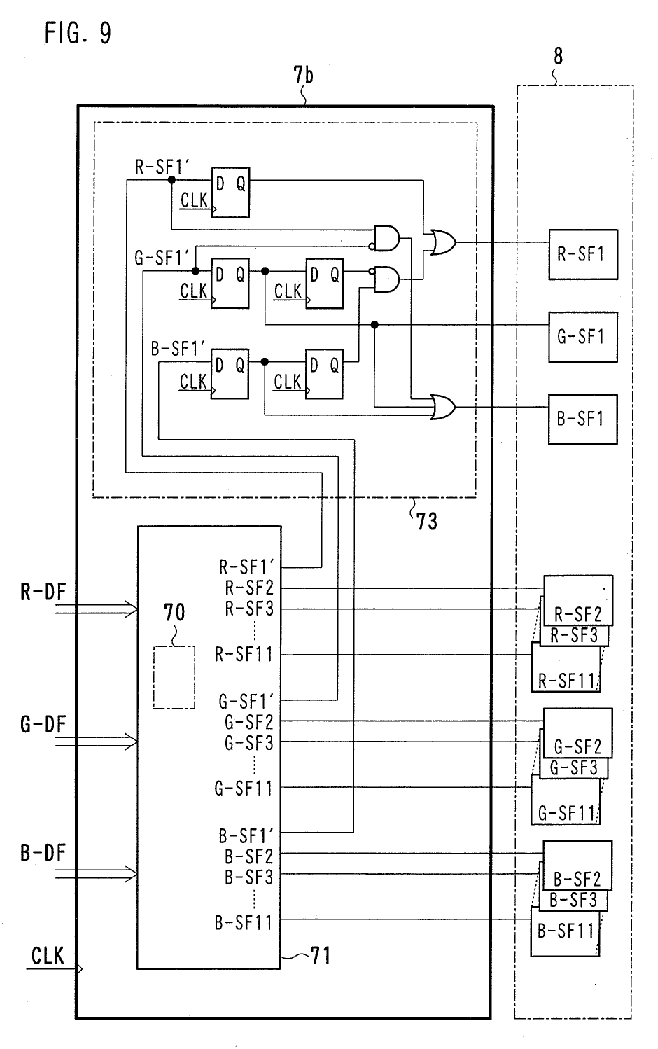

The second example of such a lighting pattern modification can be achieved by a frame division circuit 7b having a structure shown in FIG. 9.

The frame division circuit 7b includes the same block 71 as the example described above, and a logic circuit 73 that performs a logical OR operation of the subframe data R-SF1′, G-SF1′ and B-SF1′ outputted by the block 71.

As for the subframes SF2 to SF11, the subframe data outputted by the block 71 are written onto the memory 8 without any modifications. As for the leading subframe SF1, the output by the logic circuit 73 for each color is written onto the memory 8.

The logic circuit 73 includes five flip-flops for delaying data in order to generate subframe data of the subframe SF1 based on data of three pixels adjacent to one another. These flip-flops are so disposed that R is subjected to one-step data delay process and G and B are subjected to two-step data delay process. The first-stage input of the flip-flop for each color corresponds to the j+1 th pixel in FIG. 8. The first-stage output of the flip-flop corresponds to the j-th pixel. The second-stage output of the flip-flop corresponds to the j−1 th pixel.

### THIRD EXAMPLE

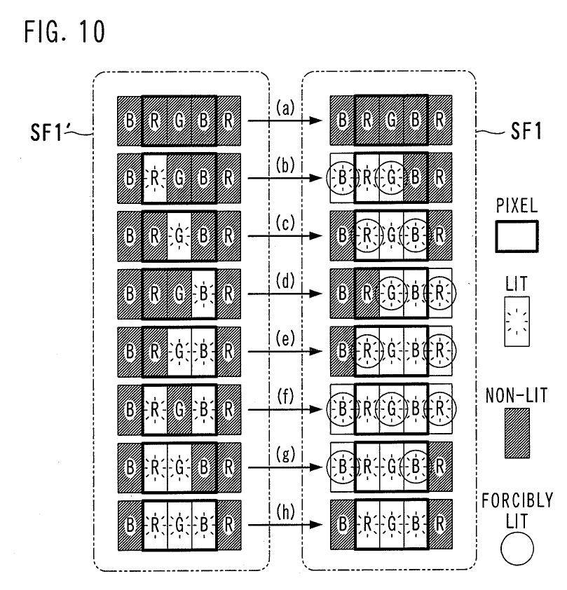

FIG. 10 is a diagram showing a third example of a lighting pattern modification. According to the third example, cells disposed on the both sides of a non-minimum brightness cell are forcibly lit, and thereby isolated lighting of the non-minimum brightness cell is eliminated.

In the case where an R cell in a target pixel is lit in isolation, a B cell in the left pixel and a G cell in the target pixel are caused to be lit as shown in (b) of FIG. 10. In the case where a G cell in a target pixel is lit in isolation, R and B cells in the target pixel are caused to be lit as shown in (c). In the case where a B cell in a target pixel is lit in isolation, a G cell in the target pixel and an R cell in the right pixel are caused to be lit as shown in (d). When G and B cells in a target pixel are lit, an. R cell in the target pixel and an R cell in the right pixel are caused to be lit as shown in (e). When R and B cells in a target pixel are lit, a B cell in the left pixel and a G cell in the target pixel and an R cell in the right pixel are lit as shown in (f). When R and G cells in a target pixel are lit, a B cell in the left pixel and a B cell in the target pixel are caused to be lit as shown in (g). These lighting pattern modifications are organized focusing on each color cell, and thereby the following logic is derived.

An R cell in a target pixel is lit in the subframe SF1 in the case where the R cell is a non-minimum brightness cell, in the case where a G cell in the target pixel is lit, or in the case where a B cell in the left pixel is lit. A G cell in a target pixel is lit in the subframe SF1 in the case where the G cell is a non-minimum brightness cell, in the case where an R cell in the target pixel is lit, or in the case where a B cell in the target pixel is lit. A B cell in a target pixel is lit in the subframe SF1 in the case where the B cell is a non-minimum brightness cell, in the case where a G cell in the target pixel is lit, or in the case where an R cell in the right pixel is lit.

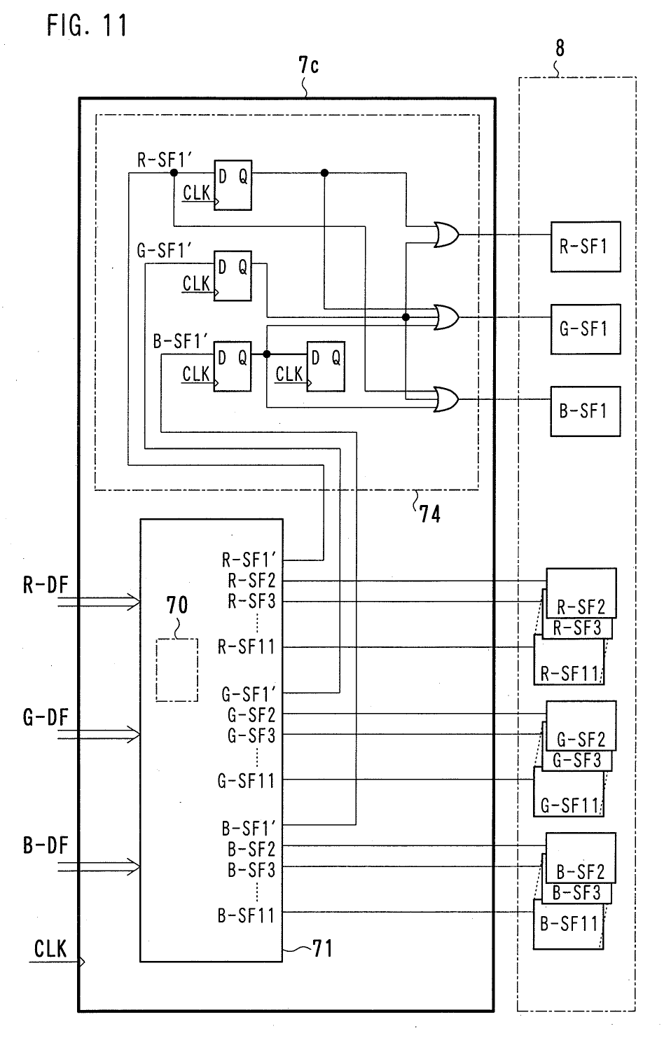

The third example of such a lighting pattern modification can be achieved by a frame division circuit 7c having a structure shown in FIG. 11. The frame division circuit 7c includes the same block 71 as the examples described above, and a logic circuit 74 that performs a logical OR operation of the subframe data R-SF1′, G-SF1′ and B-SF1′ outputted by the block 71.

As for the subframes SF2 to SF11, the subframe data outputted by the block 71 are written onto the memory 8 without any modifications. As for the leading subframe SF1, the output by the logic circuit 74 for each color is written onto the memory 8.

### FOURTH EXAMPLE

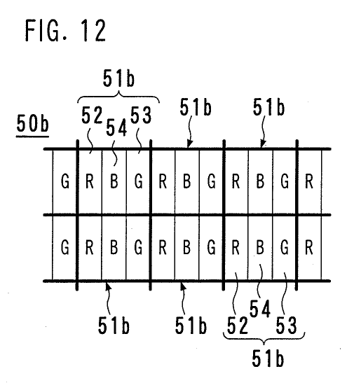

FIG. 12 is a diagram showing a color array in a screen according to a fourth example. The color array in a screen 50b shown in FIG. 12 is an array in which three colors are repeatedly provided in the order of R, B and G in the horizontal direction and cells having the same color are disposed in the vertical direction. As with the examples described above, in the screen 50b, a set of cells 51b corresponding to one pixel of an image is made up of three cells, that is, a B (blue) cell, and an R (red) cell and a G (green) cell 53 that are adjacent to the B cell. Herein, the set of cells corresponding to one pixel of an image is referred to as a pixel for convenience. The essential feature of the display 50b is that a B cell is disposed at the center of each of the pixels 51b.

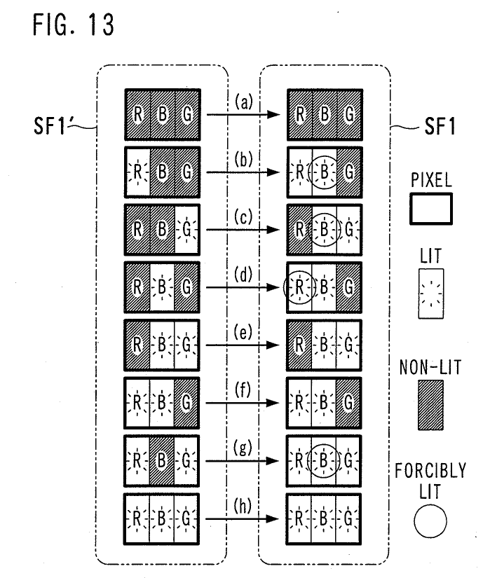

FIG. 13 is a diagram showing a fourth example of a lighting pattern modification. According to the fourth example, cells other than a non-minimum brightness cell in a pixel to which the non-minimum brightness cell belongs are forcibly lit, and thereby isolated lighting of a non-minimum brightness cell is eliminated. The fourth example enables the provision of good resolution in the horizontal direction compared to the second and third examples described above in which cells in other pixels are forcibly lit in order to eliminate isolated lighting of a non-minimum brightness cell.

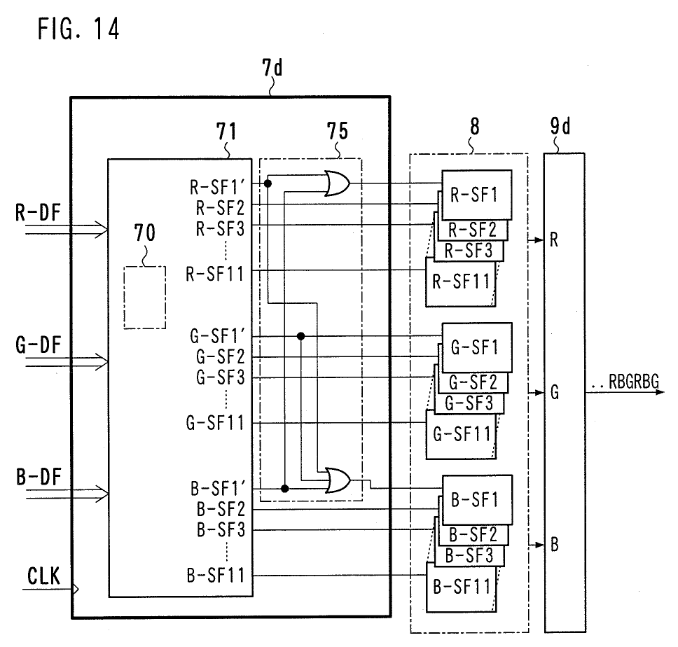

The fourth example of such a lighting pattern modification can be achieved by a frame division circuit 7d having a structure shown in FIG. 14. The frame division circuit 7d includes the same block 71 as the examples described above, and a logic circuit 75 that performs a logical OR operation of the subframe data R-SF1′, G-SF1′ and B-SF1′ outputted by the block 71.

As for the subframes SF2 to SF11, the subframe data outputted by the block 71 are written onto the memory 8 without any modifications. As for G, the subframe data of the subframe SF1′ outputted by the block 71 is written onto the memory 8 as subframe data of the subframe SF1 without any modifications. As for R and B, the output from the logical circuit 75 is written onto the memory 8 for each color as subframe data of the subframe SF1.

In the embodiments described above, the overall structure of the devices, the cell structures in the screen, the color arrays, the structures of the frame division circuit, the number of subframes corresponding to one frame, the brightness weight assigned to the subframe, the weight array, and the like may be changed as needed, in accordance with the subject matter of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A gas discharge display device comprising:
a screen for color display in which pixels are arranged in a matrix, each of the pixels being made up of three cells having different light emission colors; and
a driving circuit that is configured for replacing each multi-gradation frame with a plurality of two-gradation subframes and for performing write addressing operation on each of the subframes, so that the subframes are displayed in order,
wherein, for display of the leading subframe in display of each of the frames, the driving circuit causes, among the cells making up the screen, a non-minimum brightness cell to be lit and causes at least one cell adjacent to the non-minimum brightness cell to be forcibly lit, the non-minimum brightness cell being a cell whose corresponding multi-gradation data has a value that is not a value indicating minimum brightness.

2. The gas discharge display device according to claim 1, wherein for the display of the leading subframe in the display of each of the frames, all cells of a pixel corresponding to the non-minimum brightness cell are forcibly lit.

3. The gas discharge display device according to claim 1, wherein for the display of the leading subframe in the display of each of the frames, the non-minimum brightness cell and cells that are adjacently disposed on both sides of the non-minimum brightness cell are forcibly lit.

4. The gas discharge display device according to claim 3, wherein the pixel is made up of a cell having a light emission color of blue, a cell having a light emission color of red and a cell having light emission color of green, and the blue cell is disposed between the red cell and the green cell.

5. The gas discharge display device according to claim 1, wherein for the display of the leading subframe in the display of each of the frames, among the non-minimum brightness cell and cells that are adjacently disposed on both sides of the non-minimum brightness cell, the cell having low visibility of the light emission color is forcibly lit.
